(19) United States
(12) Patent Application Publication
(10) Pub. No.: US 2026/0107044 A1
(43) Pub. Date: Apr. 16, 2026

(54) ARTIFICIAL INTELLIGENCE (AI)-BASED SPEECH AND NON-SPEECH SUBTITLE INFORMATION GENERATION FROM MULTIMEDIA CONTENT

(71) Applicant: SONY GROUP CORPORATION, TOKYO (JP)

(72) Inventors: PANKAJ WASNIK, SAN DIEGO, CA (US); NAOYUKI ONOE, SAN DIEGO, CA (US); SAIGANESH MIRISHKAR, SAN DIEGO, CA (US); NIRMESH SHAH, SAN DIEGO, CA (US)

(21) Appl. No.: 19/353,744

(22) Filed: Oct. 9, 2025

(30) Foreign Application Priority Data
Oct. 10, 2024 (IN) 202411076968

(51) Int. Cl. H04N 21/854; G06F 40/58; G10L 17/02; G10L 25/57; G10L 25/93; H04N 21/233; H04N 21/242; H04N 21/488

(52) U.S. Cl. CPC H04N 21/854; G06F 40/58; G10L 17/02; G10L 25/57; G10L 25/93; H04N 21/233; H04N 21/242; H04N 21/4884

(57) ABSTRACT

An electronic device and method for artificial intelligence (AI)-based speech and non-speech subtitle information generation from multimedia content. The electronic device receives multimedia content including speech content. The electronic device detects the speech content from the multimedia content to determine a set of speech segments and a set of non-speech segments. The electronic device determines speech metadata based on the set of speech segments and non-speech metadata based on the set of non-speech segments. A first AI model is applied on the speech metadata and a second AI model is applied on the non-speech metadata. Voice captions associated with the multimedia content and non-voice captions associated with the multimedia content are determined. Furthermore, subtitle information associated with the multimedia content is generated, based on the voice captions and the non-voice captions. The electronic device controls rendering of the multimedia content with the subtitle information.

### CROSS-REFERENCE TO RELATED APPLICATIONS/INCORPORATION BY REFERENCE

This application claims priority to Indian Application No. IN202411076968, filed Oct. 10, 2024, which is hereby incorporated by reference in its entirety.

### FIELD

Various embodiments of the disclosure relate to subtitle information generation. More specifically, various embodiments of the disclosure relate to an electronic device and method for artificial intelligence (AI) based speech and non-speech subtitle information generation for multimedia content.

### BACKGROUND

Subtitle information generation for multimedia content has become increasingly important as the volume of audio and video content grows exponentially. While traditional methods relied on time-consuming and costly manual transcription, automated speech recognition technologies have emerged as potential solutions to streamline the process. However, current techniques face numerous challenges that impact their effectiveness and reliability. These challenges include varying accuracy due to factors such as poor audio quality, background noise, diverse accents, and regional dialects. Furthermore, the need to handle non-speech audio elements like music, sound effects, and ambient sounds, as well as accurately identify and attribute dialogue to multiple speakers, may add layers of complexity to the subtitle information generation process. The management of subtitle files across various formats and delivery platforms, including streaming services, broadcast media, and on-demand content, may further complicate the workflow. These multifaceted challenges may underscore an ongoing need for innovative and robust solutions in the field of subtitle information generation.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for artificial intelligence (AI) based speech and non-speech subtitle information generation for multimedia content is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for artificial intelligence (AI) based speech and non-speech subtitle information generation for multimedia content, in accordance with an embodiment of the disclosure.

FIG. 2 is a block diagram that illustrates an exemplary electronic device of FIG. 1, in accordance with an embodiment of the disclosure.

FIG. 3 is a block diagram of an exemplary scenario of an architecture for subtitle generation system, in accordance with an embodiment of the disclosure.

FIG. 4 is a block diagram that illustrates an exemplary scenario of architecture of system for speech and non-speech subtitle information generation of multimedia content, in accordance with an embodiment of the disclosure.

FIG. 5 is a flow diagram that illustrates an exemplary processing of multimedia content for speech and non-speech subtitle information generation, in accordance with an embodiment of the disclosure.

FIG. 6 is a flowchart that illustrates operations of an exemplary method for artificial intelligence (AI) based speech and non-speech subtitle information generation for multimedia content, in accordance with an embodiment of the disclosure.

### DETAILED DESCRIPTION

The following described implementation may be found in an electronic device and method for artificial intelligence (AI) based speech and non-speech subtitle information generation for multimedia content. Exemplary aspects of the disclosure may provide an electronic device (for example, a server, a desktop, a laptop, or a personal computer) that may generate render speech and non-speech subtitle for multimedia content based on AI model application. The electronic device may receive multimedia content including speech content. The electronic device may detect the speech content from the multimedia content to determine a set of speech segments and a set of non-speech segments. The electronic device may determine speech metadata based on the set of speech segments and non-speech metadata based on the set of non-speech segments. The speech metadata includes a spoken text, a user associated with the spoken text, and a profanity score associated with the spoken text, of the speech content. The electronic device may apply a first artificial intelligence (AI) model to the speech metadata. The electronic device may determine voice captions associated with the multimedia content, based on the applied first AI model. The electronic device may apply a second AI model to the non-speech metadata. The electronic device may determine non-voice captions associated with the multimedia content, based on the applied second AI model. The electronic device may generate subtitle information associated with the multimedia content, based on the voice captions and the non-voice captions. The electronic device may control rendering of the multimedia content with the subtitle information.

Subtitle information generation for multimedia content has become increasingly important as the volume of audio and video content grows exponentially. While traditional methods relied on time-consuming and costly manual transcription, automated speech recognition technologies have emerged as potential solutions to streamline the process. However, current techniques may face numerous challenges that impact their effectiveness and reliability. These challenges may include varied accuracy due to factors, such as, poor audio quality, background noise, diverse accents, and regional dialects. Furthermore, the need to handle non-speech audio elements like music, sound effects, and ambient sounds, as well as accurately identify and attribute dialogue to multiple speakers, may add layers of complexity to the subtitle information generation process. The management of subtitle files across various formats and delivery platforms, including streaming services, broadcast media, and on-demand content, may further complicate the workflow. These multifaceted challenges may underscore an ongoing need for innovative and robust solutions in the field of subtitle information generation.

In order to address the above requirements, the present disclosure addresses limitations of conventional subtitle information generation methods, which often rely on manual processes that are time-consuming, costly, and prone to errors. Manual subtitle creation may also lead to delays in content release and increased production expenses. In contrast, the disclosed electronic device may automate the subtitle information generation process, that may potentially reduce turnaround times and costs and also improve accuracy and consistency. Additionally, the electronic device may implement a cloud-native microservice architecture for subtitle information generation. The electronic device may allow for better scalability, fault tolerance, and easier updates compared to existing monolithic subtitle systems. The microservices may handle various aspects of subtitle information generation, such as speech detection, speech recognition, speaker identification, profanity detection, and non-speech event classification. In some cases, the electronic device may include a feedback loop to fine-tune machine learning models based on human-verified subtitles. The microservice feature may enable continuous improvement of subtitle quality over time, that may potentially reduce a need for extensive manual editing and verification in the future. Further, the electronic device may support processing of full-length movie files, that may address the needs of media content providers dealing with large-scale subtitle information generation tasks. A capability of processing larger files may particularly be beneficial for streaming services, broadcasters, and other content distributors who handle a high volume of multimedia content. Based on a combination of advanced AI techniques with a flexible, cloud-native architecture, the disclosed electronic device may offer a comprehensive solution for automated subtitle information generation that may addresses the evolving needs of the media industry.

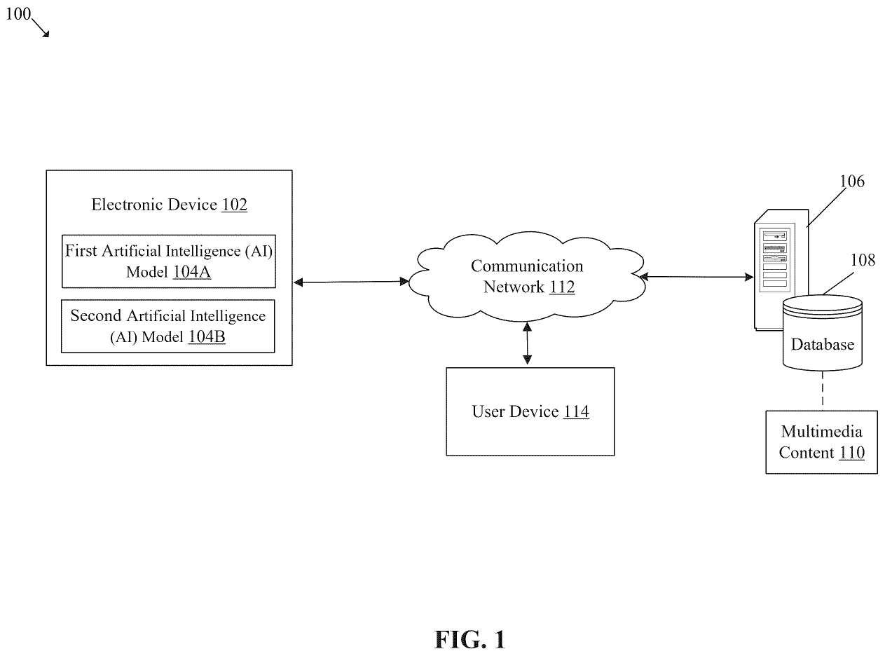

FIG. 1 is a block diagram that illustrates an exemplary network environment for artificial intelligence (AI) based speech and non-speech subtitle information generation for multimedia content, in accordance with an embodiment of the disclosure. With reference to FIG. 1, there is shown a network environment 100. The network environment 100 may include an electronic device 102, a first artificial intelligence (AI) model 104A, a second AI model 104B, a server 106, a database 108, a communication network 112, and a user device 114. As shown in FIG. 1, the electronic device 102 may include the first AI model 104A and the second AI model 104B. The electronic device 102 may be connected to the server 106 through the communication network 112. The server 106 may be coupled to the database 108, which may store the multimedia content 110. The user device 114 may also be connected to the communication network 112, which may allow communication of the user device 114 with the electronic device 102 and access to the server 106.

The electronic device 102 may include suitable logic, circuitry, interfaces, and/or code that may be configured to receive the multimedia content 110 including speech content from the server 106 or the user device 114 through the communication network 112. The electronic device 102 may detect the speech content from the multimedia content 110 to determine a set of speech segments and a set of non-speech segments. The electronic device 102 may determine speech metadata based on the set of speech segments and may determine non-speech metadata based on the set of non-speech segments. The speech metadata may include a spoken text, a user associated with the spoken text, and a profanity score associated with the spoken text, of the speech content. The electronic device 102 may determine voice captions from the speech metadata based on the first AI model 104A. Further, the electronic device 102 may determine non-voice captions from the non-speech metadata based on the second AI model 104B. The electronic device 102 may generate subtitle information associated with the multimedia content 110, based on the voice captions and the non-voice captions. The subtitle information and the multimedia content 110 may be rendered on the electronic device 102 and/or the user device 114. Examples of the electronic device 102 may include, but are not limited to, a computing device, a server, a network provider, a base station, a router, a smartphone, a cellular phone, a mobile phone, a gaming device, a mainframe machine, a computer workstation, a consumer electronic (CE) device and/or the likes.

In an embodiment, the electronic device 102 may further be configured to control a Media Asset Management (MAM) server to organize and distribute the multimedia content 110 and the generated subtitle information. In an embodiment, the electronic device 102 may be further configured to utilize job threading to concurrently process multiple subtitle information generation tasks for different portions of the multimedia content. In an embodiment, the electronic device 102 may comprise a web application programming interface (API) to enable remote access and control of the generation of the subtitle information. In an embodiment, the electronic device 102 may further configured to control a subtitle information service bus to coordinate communication between a set of microservices responsible for speech content detection, first AI model application, second AI model application, and voice caption determination, and non-voice caption determination.

In an embodiment, the electronic device 102 may further configured to receive subtitle information generation requests through a secure API gateway. The secure API gateway may be configured to authenticate the subtitle information generation requests. The electronic device 102 may be configured to route the authenticated requests to the subtitle information service bus. The electronic device 102 may be configured to distribute, by use of the subtitle information service bus, subtitle information generation tasks, associated with the routed authenticated requests, across the set of microservices.

In an embodiment, the electronic device 102 may further configured to determine a confidence score for each of the voice captions and the non-voice captions. The generation of the subtitle information may be further based on the confidence score.

In an embodiment, the electronic device 102 may further configured to segment the multimedia content into a plurality of time-based frames and detect the speech content within each of the plurality of time-based frames.

In an embodiment, the electronic device 102 may further configured to apply a speech diarization technique to identify multiple speakers within the speech content and determine an association between each of the multiple speakers and corresponding portions of the spoken text.

In an embodiment, the electronic device 102 may further configured to classify the non-speech segments into categories including at least one of music, applause, or sound effects.

In an embodiment, the electronic device 102 may further configured to filter the spoken text based on the profanity score to generate filtered voice captions. The generated subtitle information includes the filtered voice captions.

In an embodiment, the electronic device 102 may further configured to synchronize the voice captions and the non-voice captions with corresponding portions of the multimedia content.

In an embodiment, the electronic device 102 may further configured to receive a user feedback on the generated subtitle information and update at least one of the first AI model 104A or the second AI model 104B based on the user feedback.

In an embodiment, the electronic device 102 may further configured to generate a subtitle file in a standardized format based on the generated subtitle information.

In an embodiment, the electronic device 102 may further configured to detect a language of the speech content and translate the voice captions into one or more target languages. The generated subtitle information includes the translated voice captions.

In an embodiment, the electronic device 102 may further configured to adjust a display format of the generated subtitle information based on display characteristics of a rendering device.

The first AI model 104A may comprise a natural language processing model trained to analyze a context, and a sentiment of the speech metadata associated with the multimedia content 110. The natural language processing model may be specialized to understand and process human language/text input. Further, the first AI model 104A may be trained to understand the context in which the speech may be delivered. The training of the first AI model 104A for context analysis may include identifying a topic, an intent, and a relevant entity within the speech metadata. Further, the first AI model 104A may also be trained to determine the sentiment or emotional tone of the speech metadata. The training of the first AI model 104A for sentiment analysis may include classification of the speech metadata as positive, negative, or neutral, and possibly identify more nuanced emotions such as happiness, sadness, anger, etc. Additionally, the first AI model 104A may be updated based on the user feedback on the generated subtitle information. Herein, the user feedback may be received by the electronic device 102, through, for example, the user device 114.

The speech metadata may be determined based on the set of speech segments and may include a spoken text, a user associated with the spoken text, and a profanity score associated with the spoken text, of the speech content. For example, the speech metadata includes transcriptions, timestamps, speaker information, and other relevant annotations. The annotations may include context and sentiment of the speech, and labels associated with the context and sentiment. The annotations may also be associated with learning of specific language patterns with corresponding contexts and sentiments by the first AI model 104A. For example, the speech metadata extraction may involve advanced audio processing techniques to identify speakers, transcribe speech, and assess language content.

In an embodiment, the first AI model 104A may correspond to at least one of a natural language processing (NLP) model, a neural language model, a sentiment analysis model, an emotional recognition model, a Convolutional Neural Network (CNN) model, a Recurrent Neural Network (RNN) model, a Random Forest model, a Support Vector Machine (SVM) model, a recommendation system, or a classification machine learning (ML) model.

The second AI model 104B may comprise a machine learning (ML) model trained to classify non-speech audio events. In an embodiment, the ML model may be trained to identify and categorize various non-speech sounds, such as environmental noises, music, animal sounds, and other audio events. The second AI model 104B may be applied on the non-speech metadata that may be determined based on the set of non-speech segments of the speech content associated with the multimedia content 110. For example, the second AI model 104B may trained on a diverse set of audio recordings that include various non-speech sounds. The non-speech metadata may include labeled examples where each non-speech audio event may be annotated with corresponding category. Additionally, the second AI model 104B may be updated based on the user feedback on the generated subtitle information. Herein, the user feedback may be received by the electronic device 102 through, for example, the user device 114.

In an embodiment, the second AI model 104B may correspond to at least one of a supervised learning model, an unsupervised learning model, a semi-supervised learning model, a self-supervised learning model, a deep learning model, a reinforced learning model, a Convolutional Neural Network (CNN) model, a Recurrent Neural Network (RNN) model, a Random Forest model, or a Support Vector Machine (SVM) model.

The first AI model 104A and the second AI model 104B may each be a neural network model having a plurality of layers with each layer forming a loop where the outputs of each element feed into the other elements, gradually improving determination of the voice captions and the non-voice captions. The plurality of layers of the neural network model may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network model. Outputs of each hidden layer may be coupled to inputs of at least one node in other layers of the neural network model. Node(s) in the final layer may receive inputs from at least one hidden layer to output a result. The number of layers and the number of nodes in each layer may be determined from hyper-parameters of the neural network model. Such hyper-parameters may be set before, while training, or after training the neural network model on a training dataset.

Each node of the neural network model may correspond to a mathematical function (e.g., a sigmoid function or a rectified linear unit) with a set of parameters, tunable during training of the neural network model. The set of parameters may include, for example, a weight parameter, a regularization parameter, and the like. Each node may use the mathematical function to compute an output based on one or more inputs from nodes in other layer(s) (e.g., previous layer(s)) of the neural network model. All or some of the nodes of the neural network model may correspond to same or a different mathematical function.

In training of the neural network model, one or more parameters of each node of the neural network model may be updated based on whether an output of the final layer for a given input (from the training dataset) matches a correct result based on a loss function for the neural network model. The above process may be repeated for same or a different input until a minima of loss function may be achieved, and a training error may be minimized. Several methods for training are known in art, for example, gradient descent, stochastic gradient descent, batch gradient descent, gradient boost, meta-heuristics, and the like.

The neural network model may include electronic data, which may be implemented as, for example, a software component of an application executable on the electronic device 102. The neural network model may rely on libraries, external scripts, or other logic/instructions for execution by a processing device, such as, the electronic device 102. The neural network model may include code and routines configured to enable a computing device to perform one or more operations. Additionally, or alternatively, the neural network model may be implemented using hardware including a processor, a microprocessor (e.g., to perform or control performance of one or more operations, such as, determination of voice captions and non-voice captions), a field-programmable gate array (FPGA), or an application-specific integrated circuit (ASIC). Alternatively, in some embodiments, the neural network model may be implemented using a combination of hardware and software.

The server 106 may include suitable logic, circuitry, and interfaces, and/or code that may be configured to execute operations, such as data/file storage, rendering of the multimedia content 110, or generation and playback of the subtitle information. In one or more embodiments, the server 106 may store the multimedia content 110 and may execute at least one operation associated with the electronic device 102. The server 106 may be implemented as a cloud server and may execute operations through web applications, cloud applications, HTTP requests, repository operations, file transfer, and the like. Other example implementations of the server 106 may include, but are not limited to, a database server, a file server, a web server, a media server, an application server, a mainframe server, or a cloud computing server.

In at least one embodiment, the server 106 may be implemented as a plurality of distributed cloud-based resources by use of several technologies that are well known to those ordinarily skilled in the art. A person with ordinary skill in the art will understand that the scope of the disclosure may not be limited to the implementation of the server 106, the electronic device 102, as three separate entities. In certain embodiments, the functionalities of the server 106 can be incorporated in its entirety or at least partially in the electronic device 102 without a departure from the scope of the disclosure. In certain embodiments, the server 106 may host the database 108. Alternatively, the server 106 may be separate from the database 108 and may be communicatively coupled to the database 108.

The database 108 may include suitable logic, interfaces, and/or code that may be configured to store the multimedia content 110 or the generated subtitle information. The database 108 may be derived from data of a relational or non-relational database or a set of comma-separated values (csv) files in conventional or big-data storage. The database 108 may be stored or cached on a device, such as a server (e.g., the server 106), the electronic device 102. The device storing the database 108 may be configured to receive a query for the multimedia content 110 from the electronic device 102. Based on the received query, the device that stores the database 108 may retrieve and provide the multimedia content 110 to the electronic device 102.

In some embodiments, the database 108 may be hosted on a plurality of servers stored at the same or different locations. The operations of the database 108 may be executed using hardware, including a processor, a microprocessor (e.g., to perform or control performance of one or more operations), a field-programmable gate array (FPGA), or an application-specific integrated circuit (ASIC). In some other instances, the database 108 may be implemented using software. In some embodiment, the functionalities of the database 108 may be implemented by the server 106 and/or the electronic device 102, without departure from the scope of the disclosure.

The communication network 112 may include a communication medium through which the electronic device 102, the server 106, and the user device 114 may communicate with one another. The communication network 112 may be one of a wired connection or a wireless connection. Examples of the communication network 112 may include, but are not limited to, the Internet, a cloud network, Cellular or Wireless Mobile Network (such as Long-Term Evolution and 5th Generation (5G) New Radio (NR)), a Wireless Fidelity (Wi-Fi) network, a satellite network (e.g., using a network of low earth orbit satellites), a Personal Area Network (PAN), a Local Area Network (LAN), or a Metropolitan Area Network (MAN). Various devices in the network environment 100 may be configured to connect to the communication network 112 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The user device 114 may be associated with the electronic device 102 and may include suitable logic, circuitry, interfaces, and/or code that may be configured to render the multimedia content 110 along with the generated subtitle information. The electronic device 102 may control the user device 114 to playback or render the multimedia content 110 and the generated subtitle information. In certain embodiments, the user device 114 may upload (for example, based on a user-input) the multimedia content 110 to the database 108 for storage. Additionally, or alternatively, the user device 114 may transmit the multimedia content 110 to the electronic device 102.

In an embodiment, the user device 114 may comprise a web API to enable remote access and control of the generation of the subtitle information. In an embodiment, the user device 114 may include a MAM server configured to organize and distribute the multimedia content 110 and render the generated subtitle information. In an embodiment, the user device 114 may include a user interface that may allow a user to interact with the user device 114. Further, the user interface of the user device 114 may be utilized by the user to provide a user feedback on the generated subtitle information. Further, the user device 114 may transmit the user feedback to the electronic device 102.

In an embodiment, the electronic device 102 may determine display characteristics of a rendering device such as the user device 114. Then, the electronic device 102 may adjust a display format of the generated subtitle information based on the display characteristics of the user device 114 and transmit the subtitle information in the adjusted format to the user device 114. Thus, the user device 114 may render the generated subtitle information based on the adjusted display format. For example, the user device 114 may include, but are not limited to, a computing device, a server, a network provider, a smartphone, a cellular phone, a mobile phone, a gaming device, a mainframe machine, a computer workstation, a consumer electronic (CE) device and/or the likes.

In an embodiment, the user device 114 may be separate from the electronic device 102 and may be communicatively coupled to the electronic device 102, through the communication network 112. However, the scope of the disclosure may not be limited to the user device 114 being separate from the electronic device 102. In another embodiment, the user device 114 may be integrated with the electronic device 102, without departure from the scope of the disclosure,

In operation, the electronic device 102 may be configured to receive the multimedia content 110 including speech content from the server 106 or the user device 114. By way of example, and not limitation, the multimedia content 110 may be a podcast, a video, a movie, an audio, a webinar, a music piece, an infographic sequence, animation, or a virtual reality (VR) experience. For example, and not limitation, the speech content may be the portion of multimedia content 110 that consists of spoken language. By way of example, and not limitation, the speech content may include human speech, that may be in the form of dialogues, monologues, narrations, or any other spoken communication.

The electronic device 102 may be configured to detect the speech content from the multimedia content 110 to determine a set of speech segments and a set of non-speech segments. The electronic device 102 may determine speech metadata based on the set of speech segments and non-speech metadata the set of non-speech segments. The speech metadata includes a spoken text, a user associated with the spoken text, and a profanity score associated with the spoken text, of the speech content.

The spoken text may be determined based on a speech processing technique using a speech recognition model. The spoken text may refer to a textual representation of spoken language that has been converted from audio signals through various computational techniques. The speech processing involves analysis and interpretation of an audio input to produce an accurate and readable text output.

The user associated with the spoken text may be a user who delivers a dialogue in the multimedia content 110. The user may be responsible for speaking the lines that are converted into the spoken text by use of speech processing and recognition techniques. The user's identity, voice characteristics, and emotional expression may be integral to the spoken text, and such information may be used in various applications such as speaker identification, content personalization, and analytics.

The profanity score associated with the spoken text may be a measure that quantifies the presence and severity of profane language. The profanity score may be calculated based on the detection, frequency, and severity of offensive words and phrases. The profanity score may be used in various applications, including content moderation, parental controls, compliance, and content rating, to ensure that speech content is appropriate for an intended audience of the multimedia content 110.

The electronic device 102 may be configured to apply the first AI model 104A to the speech metadata. The application of the first AI model 104A may include utilization of ML algorithms to analyze the speech metadata related to the speech content in set of speech segments. Based on the applied first AI model 104A, the electronic device 102 may be configured to determine voice captions associated with the multimedia content 110. These voice captions may accurately represent the spoken content in a textual form.

The electronic device 102 may be configured to apply the second AI model 104B to the non-speech metadata. The application of the second AI model 104B may include utilization of specialized algorithms to interpret non-speech audio elements. The electronic device 102 may be configured to determine non-voice captions associated with the multimedia content 110 based on the applied second AI model 104B. The non-voice captions may describe relevant audio events or background sounds.

The electronic device 102 may be configured to generate subtitle information associated with the multimedia content 110, based on the voice captions and the non-voice captions. The generated subtitle information may include combining and formatting the different types of captions such as the voice captions and the non-voice captions into a cohesive subtitle stream.

The electronic device 102 may be configured to control rendering of the multimedia content 110 with the generated subtitle information. The control may involve a synchronization of the subtitles with video content and management display characteristics of the synchronized video content for rendering on the user device 114.

Subtitle information generation for multimedia content has become increasingly important as the volume of audio and video content grows exponentially. While traditional methods relied on time-consuming and costly manual transcription, automated speech recognition technologies have emerged as potential solutions to streamline the process. However, current techniques face numerous challenges that impact their effectiveness and reliability. These challenges include varying accuracy due to factors such as poor audio quality, background noise, diverse accents, and regional dialects. Furthermore, the need to handle non-speech audio elements like music, sound effects, and ambient sounds, as well as accurately identify and attribute dialogue to multiple speakers, may add layers of complexity to the subtitle information generation process. The management of subtitle files across various formats and delivery platforms, including streaming services, broadcast media, and on-demand content, may further complicate the workflow. These multifaceted challenges underscore the ongoing need for innovative and robust solutions in the field of subtitle information generation.

In order to address the requirements, the present disclosure address limitations of conventional subtitle information generation methods, which often rely on manual processes that are time-consuming, costly, and prone to errors. Manual subtitle creation may also lead to delays in content release and increased production expenses. In contrast, the disclosed electronic device 102 may automate the subtitle information generation process, that may potentially reduce turnaround times and costs and also improve accuracy and consistency. Additionally, the electronic device 102 may implement a cloud-native microservice architecture for subtitle information generation. The electronic device 102 may allow for better scalability, fault tolerance, and easier updates compared to monolithic subtitle systems. The microservices may handle various aspects of subtitle information generation, such as speech detection, speech recognition, speaker identification, profanity detection, and non-speech event classification. In some cases, the electronic device 102 may include a feedback loop to fine-tune machine learning models based on human-verified subtitles. The microservice feature may enable continuous improvement of subtitle quality over time, potentially reducing the need for extensive manual editing and verification in the future. Further, the electronic device 102 may support processing of full-length movie files, that may address the needs of media content providers who deal with large-scale subtitle information generation tasks. The capability to process larger files may particularly be beneficial for streaming services, broadcasters, and other content distributors who handle a high volume of multimedia content. Based on a combination of advanced AI techniques with a flexible, cloud-native architecture, the disclosed electronic device 102 may offer a comprehensive solution for automated subtitle information generation that addresses the evolving needs of the media industry.

In comparison to traditional subtitle information generation methods, that often rely on manual transcription and timing, the disclosed techniques offer several advantages. The use of AI models for both determination of voice captions and non-voice captions from the speech metadata and the non-speech metadata, respectively, may allow for faster, more accurate subtitle information generation. The disclosed technique's ability to handle non-speech audio elements and provide comprehensive metadata may enhances the subtitling process beyond simple transcription. Additionally, the cloud-based architecture may allow for scalability and easy integration with existing media asset management systems, that may potentially reduce production time and costs for content providers.

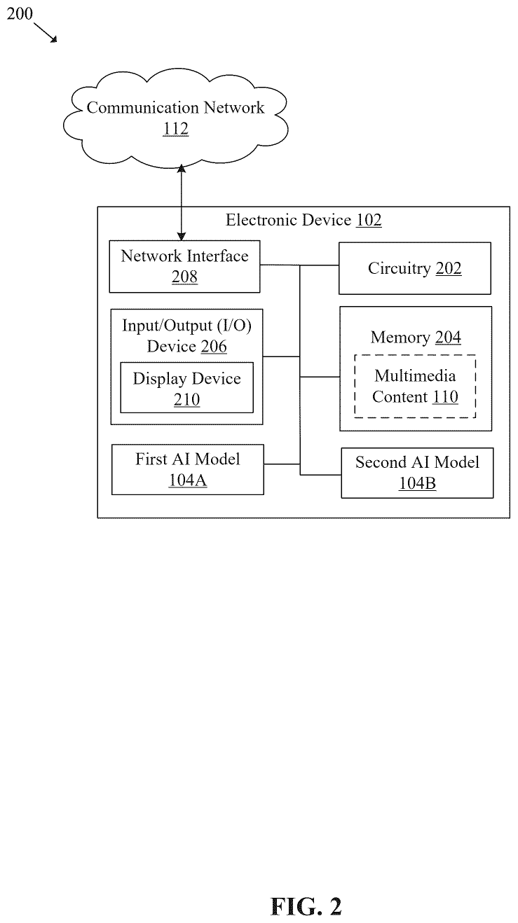

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the electronic device 102. The electronic device 102 may include a circuitry 202, a memory 204, an input/output (I/O) device 206, a network interface 208, the first AI model 104A, and the second AI model 104B. The input/output (I/O) device 206 may include a display device 210.

The circuitry 202 may include suitable logic, circuitry, and/or interfaces that may be configured to execute program instructions associated with different operations to be executed by the electronic device 102. For example, the operations may include multimedia content reception, speech content detection, speech metadata and non-speech metadata determination, first AI model application, voice caption determination, second AI model application, non-voice caption determination, subtitle information generation, and control of rendering. The circuitry 202 may include one or more processing units, which may be implemented as a separate processor. In an embodiment, the one or more processing units may be implemented as an integrated processor or a cluster of processors that perform the functions of the one or more specialized processing units, collectively.

The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202 (and/or the electronic device 102) to perform the operations of the circuitry 202 (and/or the electronic device 102). The memory 204 may be configured to store the multimedia content 110, the generated subtitle information, and data associated with the user device 114. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive the multimedia content 110 including speech content. Further, the I/O device 206 may control rendering of the multimedia content 110 and the generated subtitle information. The I/O device 206 may include the display device 210. Examples of the I/O device 206 may include, but are not limited to, a touch screen, a keyboard, a mouse, a joystick, a microphone, or a speaker.

The network interface 208 may include suitable logic, circuitry, interfaces, and/or code that may be configured to facilitate communication between the electronic device 102 and the server 106 via the communication network 112. The network interface 208 may be implemented by use of various known technologies to support wired or wireless communication of the electronic device 102 with the communication network. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display the subtitle information, and the multimedia content 110 (such as a video, a movie along with the subtitle information including the voice captions and the non-voice captions) after processing. The display device 210 may be a touch screen which may enable a user to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display.

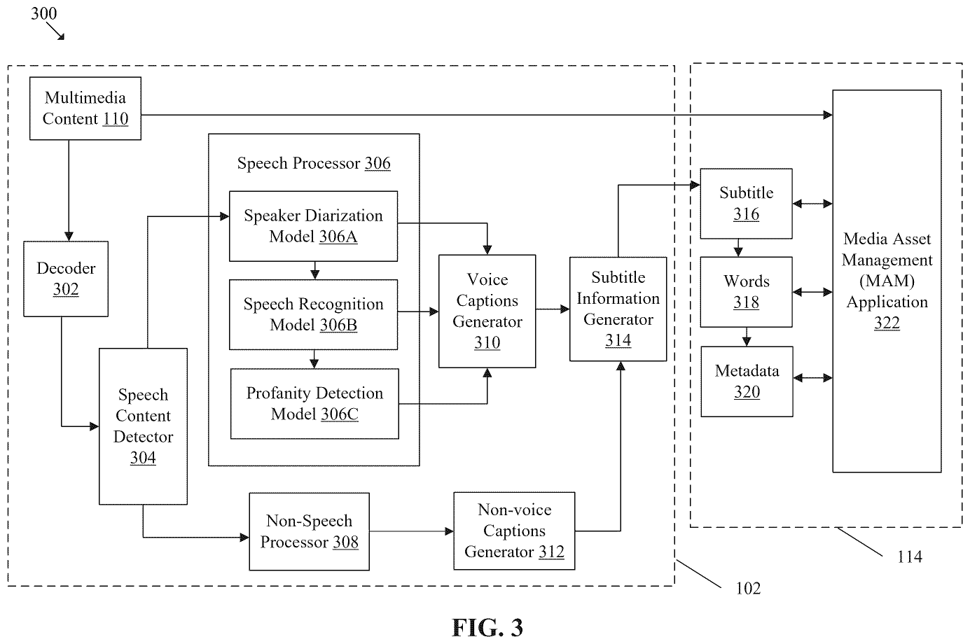

FIG. 3 is a block diagram of an exemplary scenario of an architecture for subtitle generation system, in accordance with an embodiment of the disclosure. FIG. 3 is explained in conjunction with elements from FIG. 1 and FIG. 2. With reference to FIG. 3, there is shown an exemplary scenario 300 for subtitle generation system that illustrates components 302 to 322. The various components of the scenario 300 include a decoder 302, a speech content detector 304, a speech processor 306, a non-speech processor 308, a voice captions generator 310, a non-voice captions generator 312, a subtitle information generator 314, subtitles 316, words 318, metadata 320, and a media asset management (MAM) application 322. In an embodiment, the electronic device 102 may include the decoder 302, the speech content detector 304, the speech processor 306, the non-speech processor 308, the voice captions generator 310, the non-voice captions generator 312, and the subtitle information generator 314. Further, the user device 114 may include the subtitles 316, the words 318, the metadata 320, and the MAM application 322.

As shown in FIG. 3, the decoder 302 may be connected to the speech content detector 304. The speech content detector 304 may be connected to both the speech processor 306 and the non-speech processor 308. The speech processor 306 may be connected to the voice captions generator 310, while the non-speech processor 308 may be connected to the non-voice captions generator 312. Both the voice captions generator 310 and the non-voice captions generator 312 may be connected to the subtitle information generator 314. The subtitle information generator 314 may output the subtitles 316, the words 318, and the metadata 320, that may be provided to the MAM application 322.

The decoder 302 is configured to receive multimedia content 110, which includes speech content, from various sources such as the server 106, user device 114, cloud storage services, or streaming platforms. The multimedia content 110 may encompass a wide range of formats, including but not limited to video files (e.g., MP4, AVI, MOV), audio recordings (e.g., MP3, WAV, AAC), live streams, podcasts, and interactive media such as video games or virtual reality content. Upon receipt, the decoder 302 may prepares the multimedia content 110 for subsequent analysis through a series of preprocessing steps. These steps may include demultiplexing audio and video streams, decoding compressed formats, and normalizing audio levels. In some implementations, the decoder 302 may also perform initial noise reduction or audio enhancement techniques to improve the quality of the speech content.

One key function of the decoder 302 may be the extraction of speech content from complex multimedia files. For instance, when a movie file is processed, the decoder 302 may isolate the audio track and further separate the speech components from background music, sound effects, or ambient noise. This extraction process may involve techniques such as audio segmentation, voice activity detection, and frequency analysis to distinguish speech from other audio elements. The decoder 302 may employ adaptive algorithms to handle various audio characteristics, such as different speaker accents, speaking rates, or recording conditions. In some cases, it may use machine learning models trained on diverse audio datasets to improve its extraction capabilities across a wide range of content types.

Following the speech extraction, the decoder 302 may convert the speech content into a standardized format optimized for processing and analysis. This standardization may include transforming the audio into a specific file format (e.g., WAV, FLAC), adjusting the sampling rate to a consistent value (e.g., 16 kHz), or applying audio codecs optimized for speech processing. The choice of standardized format depends on the requirements of subsequent analysis modules and the specific application of the system. In some implementations, the decoder 302 may generate intermediate representations of the speech content, such as mel-frequency cepstral coefficients (MFCCs) or spectrogram images, which can be directly fed into machine learning models for further analysis. The decoder 302 may also incorporate error handling and recovery mechanisms to deal with corrupted or incomplete multimedia files, ensuring robust operation even when processing imperfect input data. Additionally, it may implement caching or streaming techniques to efficiently handle large multimedia files or real-time content without excessive memory usage.

The speech content detector 304 may analyze the prepared speech content to determine the set of speech segments and the set of non-speech segments. The speech content detector 304 may segment the multimedia content 110 into time-based frames for analysis. The prepared speech content may be used to determine the speech metadata based on the set of speech segments and the non-speech metadata based on the set of non-speech segments. The speech metadata may include the spoken text, the user associated with the spoken text, and the profanity score associated with the spoken text, of the speech content.

Further, the electronic device 102 may leverage the speech processor 306 by application of the first AI model 104A on the speech metadata. The speech processor 306 may comprises a speaker diarization model 306A, a speech recognition model 306B, and a profanity detection model 306C.

The speaker diarization model 306A may apply speech diarization techniques to the set of speech segments to identify multiple speakers within the speech content. Additionally, the speaker diarization model 306A may determine an association between each of the multiple speakers and corresponding portions of the spoken text. For example, a user may be associated with a spoken text if the user is detected as speaking the text during a dialogue delivery in the multimedia content 110. The speaker diarization model 306A may determine user information including the identity, the voice characteristics, and the emotional expression associated with the spoken text for each user detected in the spoken text. Further the user information may be used in various applications such as speaker identification, content personalization, and analytics.

The speaker diarization model 306A may use clustering techniques to group speech segments from the same speaker. In some cases, speaker diarization model 306A may employ a Gaussian mixture model to model the acoustic characteristics of different speakers. Further, the speaker diarization model 306A may utilize deep learning approaches such as convolutional neural networks or recurrent neural networks to extract speaker-specific features from the audio signal. These features may then be used to distinguish between different speakers. In some implementations, the speaker diarization model 306A may incorporate visual information, if available, to improve speaker identification accuracy. For example, the speaker diarization model 306A may use lip movement detection or face recognition in video content to determine which person is speaking. The speaker diarization model 306A may employ an iterative refinement process, where initial speaker segmentation is performed and then iteratively improved by re-evaluation of segment boundaries and speaker assignments. In some respects, the speaker diarization model 306A may maintain speaker profiles across multiple pieces of content. This may allow for improved identification of known speakers in new content. The speaker diarization model 306A may use voice activity detection as a preprocessing step to isolate speech segments before attempting to distinguish between speakers. In some implementations, the speaker diarization model 306A may incorporate natural language processing techniques to leverage linguistic cues for speaker changes, such as analysis of sentence structures or identification of turn-taking patterns in conversations.

The speech recognition model 306B may convert spoken words of the set of speech metadata in the multimedia content 110 into text. The spoken text may be determined based on a speech processing technique using a speech recognition model. The spoken text may refer to a textual representation of spoken language that has been converted from audio signals through various computational techniques. The speech recognition model 306B may include analysis and interpretation of the audio input to produce an accurate and readable text output. Examples of the speech recognition model 306B may include, but are not limited to, deep neural networks (such as long short-term memory (LSTM) networks or a transformer model (such as, a Bidirectional Encoder Representations from Transformers (BERT) model and a Generative Pre-trained Transformer (GPT) model)), a neural language model, and the likes. In some implementations, the speech recognition model 306B may employ a hybrid approach combining neural networks with Hidden Markov Models (HMMs).

The profanity detection model 306C may be an AI model to identify and quantify offensive language in text by calculating the profanity score. The profanity score represents the intensity or likelihood of profane content within the input. Further, the profanity detection model 306C may analyze the converted text and assign the profanity score to each word or phrase. The profanity score may be associated with the spoken text may be a measure that quantifies the presence and severity of profane language. The profanity score may be calculated based on the detection, frequency, and severity of offensive words and phrases. The profanity scores may be used in various applications, including content moderation, parental controls, compliance, and content rating, to ensure that speech content is appropriate for an intended audience.

The profanity detection model 306C may utilize a combination of dictionary-based matching and machine learning techniques to identify potentially offensive language. In some implementations, profanity detection model 306C may employ natural language processing to understand context and distinguish between benign and offensive uses of words. The profanity detection model 306C may incorporate a customizable list of profane words and phrases that can be updated based on specific content guidelines or regional variations in language use. In some cases, the profanity detection model 306C may use deep learning models, such as convolutional neural networks or recurrent neural networks, trained on large datasets of labeled text to identify profanity and offensive language. The profanity detection model 306C may implement fuzzy matching algorithms to catch intentional misspellings or obfuscations of profane words that are meant to evade detection. In some respects, the profanity detection model 306C may analyze surrounding context to determine the intent and severity of potentially offensive language, that may allow a more nuanced classification beyond simple word matching.

In some cases, the profanity detection model 306C may incorporate sentiment analysis techniques to identify negative or hostile language that may be considered inappropriate even if it doesn't contain explicit profanity. In some implementations, the profanity detection model 306C may use multi-lingual models to identify profanity across different languages and dialects within the same piece of content. The profanity detection model 306C may employ a sliding window approach to analyze phrases and sentences, allowing it to catch multi-word profanities or offensive expressions that span across multiple words. Examples of the profanity detection model 306C may include, but are not limited to, deep neural networks (such as long short-term memory (LSTM) networks or a transformer model (such as, a Bidirectional Encoder Representations from Transformers (BERT) model and a Generative Pre-trained Transformer (GPT) model)), a neural language model, and the likes. In some implementations, the profanity detection model 306C may employ a hybrid approach combining neural networks with Hidden Markov Models (HMMs).

The electronic device 102 may leverage the non-speech processor 308 by application of the second AI model 104B. The non-speech processor 308 may analyze and classify the non-speech audio event. In some cases, the non-speech processor 308 may classify non-speech audio event into specific categories such as baby crying, engine starting, people cheering and the likes. The non-speech metadata may include background noise for example, but not limited to traffic noise, wind, birds chirping in outdoor scenes, air conditioning hum, refrigerator buzz, echoes in a room, chatter, footsteps, the clinking of utensils, paper rustling, distant car horns, or background music from a nearby source can contribute.

The non-speech processor 308 may employ convolutional neural networks (CNNs) to classify various types of non-speech audio events. In some implementations, non-speech processor 308 may use spectrogram analysis to identify patterns characteristic of specific sounds like applause, laughter, or music. The non-speech processor 308 may incorporate a database of pre-classified sound effects to identify common non-speech audio elements in media content. Such a database may be continuously updated with new sound samples to improve recognition accuracy.

In some cases, the non-speech processor 308 may utilize ensemble learning techniques, based on a combination of multiple classifiers such as support vector machines, random forests, and neural networks to improve overall classification accuracy for non-speech sounds. The non-speech processor 308 may implement adaptive thresholding techniques to distinguish between background noise and meaningful non-speech audio events, to adjust a sensitivity of detection based on the overall audio characteristics of the content.

In some respects, the non-speech processor 308 may use recurrent neural networks (RNNs) or long short-term memory (LSTM) networks to capture temporal dependencies in non-speech audio, to allow for better classification of sounds that evolve over time. The non-speech processor 308 may employ audio fingerprinting techniques to identify specific music tracks or known sound effects within the content, to provide more detailed metadata for non-speech elements. In some implementations, the non-speech processor 308 may incorporate multi-modal analysis, based on a combining audio features with visual cues from video content to improve classification accuracy for events like explosions or car crashes. The non-speech processor 308 may use unsupervised learning techniques like clustering to identify and group similar non-speech sounds, to potentially discover new categories of audio events not previously defined in its classification system.

The voice captions generator 310 may process the output from the speech processor 306 to create voice captions. In an embodiment, the voice captions generator 310 may filter the spoken text based on the profanity score to generate filtered voice captions. In an embodiment, the electronic device 102 may detect a language of the speech content. Further, the electronic device 102 may leverage the voice captions generator 310 to translate the voice captions into one or more target languages.

The voice captions generator 310 may utilize natural language processing techniques to format the transcribed text into grammatically correct and readable captions. In some implementations, it may employ sentence segmentation algorithms to break long speech segments into manageable caption lengths. The voice captions generator 310 may incorporate speaker identification information to assign different colors or labels to captions from different speakers, enhancing readability and comprehension for viewers. In some cases, the voice captions generator 310 may use machine learning models to predict optimal caption timing and duration based on factors such as speech rate, sentence complexity, and visual content pacing. The voice captions generator 310 may implement text normalization techniques to convert numbers, abbreviations, and special characters into their spoken forms, ensuring consistency between the audio and caption text.

In some respects, the voice captions generator 310 may use sentiment analysis to add appropriate punctuation or formatting to the captions, such as exclamation marks for excited speech or ellipses for hesitations. The voice captions generator 310 may employ language models to correct minor transcription errors or fill in gaps in the speech recognition output, improving the overall quality and coherence of the captions. In some implementations, the voice captions generator 310 may use named entity recognition to identify and properly capitalize names of people, places, and organizations within the caption text. The voice captions generator 310 may incorporate a profanity filter (that may use, for example, the profanity scores generated by the profanity detection model 306C) that can either censor or replace identified profane words. The profanity filter may work based on user preferences or content guidelines and may maintain the overall meaning of the speech.

The non-voice captions generator 312 may process the non-speech metadata from the non-speech processor 308 to create non-voice captions describing relevant background sounds or events. The non-voice captions generator 312 may use a combination of rule-based systems and machine learning models to convert classified non-speech audio events into descriptive text captions. In some implementations, it may employ natural language generation techniques to create varied and context-appropriate descriptions for recurring sounds. The non-voice captions generator 312 may incorporate a customizable template system that allows for different caption styles based on the type of content or target audience, such as more detailed descriptions for educational content or simpler captions for children's programming. In some cases, the non-voice captions generator 312 may utilize sentiment analysis to infer the emotional context of non-speech sounds and allow generation of captions that convey not just the sound itself but its mood or impact on the scene.

The non-voice captions generator 312 may implement a priority ranking system to determine which non-speech sounds are most relevant to the content and the most relevant non-speech sounds may be captioned and avoid overcrowding a screen with less important audio descriptions. In some respects, the non-voice captions generator 312 may use machine learning models trained on human-written captions to generate more natural and idiomatic descriptions of complex audio events. The non-voice captions generator 312 may employ context-aware algorithms that consider the visual content and previous captions to generate more relevant and coherent non-voice captions that align with the overall narrative. In some implementations, the non-voice captions generator 312 may incorporate intensity estimation to describe the volume or prominence of non-speech sounds, using modifiers like “faint,” “loud,” or “overwhelming” to provide viewers with a more accurate representation of the audio experience. The non-voice captions generator 312 may also use temporal analysis to describe the duration and pattern of non-speech sounds, generating captions like “intermittent gunfire” or “continuous applause” to convey the nature of ongoing audio events.

The subtitle information generator 314 may combine the voice captions and non-voice captions to generate comprehensive subtitle information. The subtitle information generator 314 may synchronize the voice captions and non-voice captions with corresponding segments of the multimedia content 110. In an embodiment, the generated subtitle information includes the translated voice captions. Additionally, the subtitle information generator 314 may be configured to determine a confidence score for each of the voice captions and the non-voice captions that may further be utilized in generation of the subtitle information.

In an embodiment, the subtitle information generator 314 may generate a subtitle file in a standardized format based on the generated subtitle information. The subtitle information generator 314 may also generate a JavaScript Object Notation (JSON)-formatted output containing detailed subtitle information. For example, the JSON-formatted output may be as follows:

```
  Listing 1: JSON formatted example output
  {
  “statusCode”: 200,
  “body”: {
  “message”: “STATUS_OK”,
  “profane_wordlist”: [ ],
  “status”: “COMPLETED”,
  “status_code”: “STATUS_OK”,
  “transcripts”: [
  {
  “end_time”: “4.784062499999999”,
  “end_timestamp”: “00:00:04.784”,
  “profane_transcript”: “”,
  “speaker”: “SPEAKER_00”,
  “start_time”: “0.4978125”,
  “start_timestamp”: “00:00:00.498”,
  “transcript”: “DON'T YOU JUST LOVE TO LAUGH.”,
  “verbal”: “True”
  },
  {
  “class”: “Music”,
  “end_time”: “29.9615625”,
  “end_timestamp”: “00:00:29.962”,
  “start_time”: “27.6328125”,
  “start_timestamp”: “00:00:27.633”,
  “verbal”: “False”
  }
  ]
  }
}
```

The subtitles 316, words 318, and metadata 320 may be the final outputs of the subtitle information generation process. The subtitles 316 may include both the voice captions and the non-voice captions. The words 318 may be individual words extracted from the speech content with filter the spoken text based on the profanity score. The metadata 320 may include additional information such as speaker identification, language detection, and timing information.

The media asset management (MAM) application 322 may be a software tool designed to organize, store, and manage digital media assets, such as video files, audio recordings, images, and metadata. The MAM application 322 may receive and manage the generated subtitle information. In some cases, the media asset management application 322 may be part of a larger media asset management system implemented on the server 106. For example, the MAM application 322 may specifically handle and manage the generated subtitle information related to the multimedia content 110. The MAM application 322 may serve as a component of a broader Media Asset Management system that may be hosted on a server (e.g., the server 106), integrating various processes like media cataloging, storage, and retrieval. The application ensures efficient handling of media-related data, enabling streamlined workflows for editing, distribution, and collaboration in media production and management environments.

In the subtitle information generation process, the first AI model 104A may be applied to the speech metadata. In some cases, the first AI model 104A may be a natural language processing model trained for context and sentiment analysis of the speech content. The second AI model 104B may be applied to the non-speech metadata. In some cases, the second AI model 104B may be a machine learning model trained to classify non-speech audio events. In an embodiment, the electronic device 102 may detect the language of the speech content. The electronic device 102 may then translate the voice captions into one or more target languages. The translated voice captions may be included in the generated subtitle information.

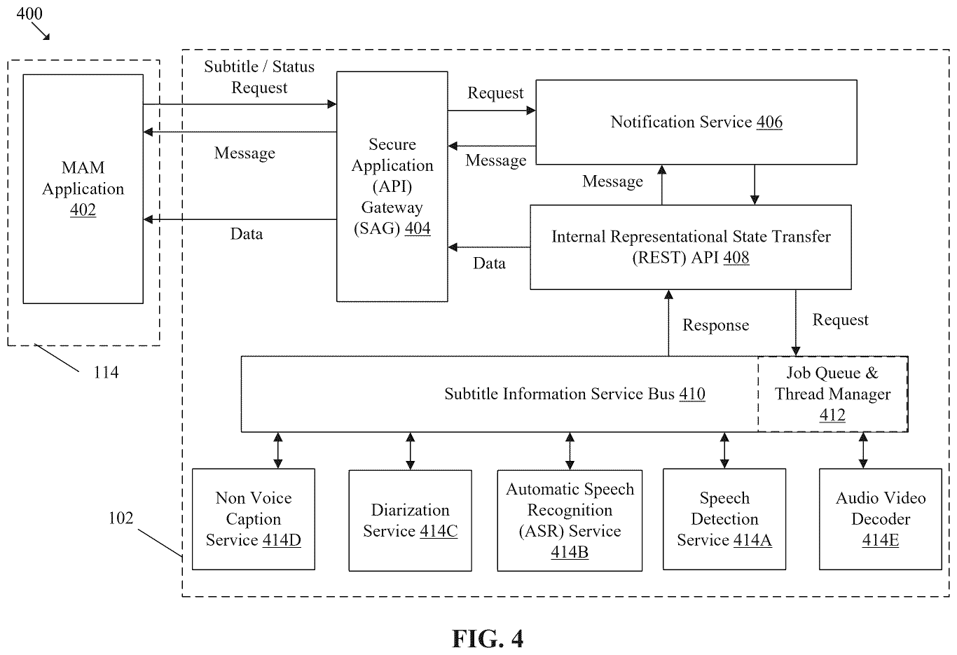

FIG. 4 is a block diagram that illustrates an exemplary scenario of architecture of system for speech and non-speech subtitle information generation of multimedia content, in accordance with an embodiment of the disclosure. FIG. 4 is explained in conjunction with elements from FIG. 1, FIG. 2, and FIG. 3. With reference to FIG. 4, an exemplary scenario 400 of a system for speech and non-speech subtitle information generation of multimedia content is shown, The scenario 400 includes the user device 114 including a MAM application 402; and the electronic device 102 including a Secure API gateway (SAG) 404, a notification service 406, an internal Representational State Transfer (REST) API 408, a subtitle information service bus 410, a job queue & thread manager 412, a non-voice caption service 414D, an automatic speech recognition (ASR) service 414B, a diarization service 414C, a speech detection service 414A, and an audio/video decoder 414E (such as, the decoder 302). The media asset management application 402 may be connected to the SAG 404, which may be connected to the notification service 406 and the internal REST API 408. The internal REST API 408 may be connected to the subtitle information service bus 410, which may be connected to the job queue & thread manager 412 and the various microservices (414A-414E).

The MAM application 402 may serve as a client interface of the MAM application (such as, the MAM application 322) that may enable users of the user device 114 to initiate and manage workflows related to the multimedia content 110. For example, in the context of the subtitle information generation, the MAM application 402 may provide a graphical web interface for the users of the user device 114. The graphic web interface may configure parameters such as a unique file ID, target language, and profanity detection. The users of the user device 114 may provide a user input including an update in the parameters such as the unique file ID, the target language, or the profanity detection. The MAM application 402 may receive the user input. The MAM application 402 (or the MAM application 322) may then process the user input based on a transmission of the multimedia content 110 and associated parameters to a subtitle service API gateway (such as, the SAG 404), that also includes necessary access credentials in a request header.

Further, the MAM application 402 may interact with the subtitle information generator (such as, the subtitle information generator 314) to manage the overall process of organization and distribution of the multimedia content 110. In an embodiment, the MAM application 402 also manage the subtitle information generation, storage, and distribution. The MAM application 402 may send requests through the SAG 404 and receive the generated subtitle information and associated metadata for integration with the multimedia content 110. The MAM application 402 may provide a scalable and efficient system for automated subtitle information generation, which may leverage specialized microservices and robust management components to handle complex multimedia processing tasks.

The SAG 404 may be a secure entry point to manage and route the user request for the subtitle information generation. The electronic device 102 may receive subtitle information generation requests through the SAG 404. The SAG 404 may be configured to authenticate the subtitle information generation requests. Upon receipt of the subtitle information generation requests, the SAG 404 may be configured to verify credentials of the user device 114 to ensure access to the service for the user device 114. The SAG 404 may parse a command from parameters associated with the subtitle information generation request and initiate execution of a process for the subtitle information generation. The subtitle information service may support two main commands, such as a status, and a subtitle. The status may check the progress of subtitle information generation and return cached results if available. The status may be utilized by the MAM application 402 to schedule a retrieval of the multimedia content 110 with the subtitle information based on its availability. Further the subtitle information service bus 410 may initiate a new job for subtitle information generation or returns cached results if the file (such as a subtitle information file) has already been generated. The subtitle may be added to a job query of the job queue & thread manager 412 when the initiated new job file (such as the subtitle information file) has not been generated. The secure and efficient management of requests may help to manage the workflow associated with the subtitle information generation, resource allocation for subtitle information generation, and status tracking of the subtitle information generation.

Further, the SAG 404 may route the subtitle information generation request to the notification service 406 or to a subtitle information generator (such as, the subtitle information generator 314). Also, the SAG 404 may perform a load balancing of the received subtitle information generation requests. The SAG 404 may ensure secure and efficient communication between the user device 114 and the electronic device 102 (or internal services of the electronic device 102). In an embodiment, the electronic device 102 may receive subtitle information generation requests through the SAG 404. The SAG 404 may be configured to authenticate the subtitle information generation requests before the subtitle information generation requests may be routed to an appropriate internal component of the electronic device 102, such as, the subtitle information service bus 410.

The notification service 406 may implement a real-time communication system between various components of the subtitle information generation system of the scenario 400. This communication system may utilize protocols such as WebSocket or Server-Sent Events to ensure low-latency message delivery across the communication network 112. The notification service 406 may facilitate the exchange of status updates, error messages, and other information between the different microservices and management modules. In some cases, the notification service 406 may employ encryption techniques and authentication mechanisms to secure the communication channels between components. This may help protect sensitive information, such as user data or proprietary algorithms, from unauthorized access or interception.

The notification service 406 may receive subtitle information generation requests from the secure API gateway 404 and transmit the received requests to the subtitle information service bus 410. For example, the notification service 406 may receive messages from any subscriber and publish the received messages to all relevant subscribers. The subscribers may include the media asset management application 402, the internal REST API 408, and the various microservices (414A-414E). Commands, messages, or requests from the media asset management application 402 may be routed through the notification service 406, which may process the incoming data to initiate the internal REST API 408 as needed. The notification service 406 may implement message queuing systems to handle high volumes of requests and ensure reliable message delivery, even during network disruptions or system failures.

In some implementations, the notification service 406 may communicate notifications such as service failures, successes, and other miscellaneous scenarios to the media asset management application 402. These notifications may include, for example, progress updates on subtitle generation tasks (e.g., “25% of audio processed”, “Speech recognition complete”), error messages (e.g., “Audio decoding failed”, “Insufficient storage space”), System status alerts (e.g., “High CPU usage detected”, “Network latency increased”), and/or Job completion notifications (e.g., “Subtitle generation complete for file XYZ”).

The notification service 406 may play a crucial role in several scenarios, such as, load balancing, error handling, user feedback, and system monitoring. For example, based on a broadcast of real-time information about the status of various microservices, the notification service 406 may assist in distribution of workloads efficiently across available resources. Further, when a microservice encounters an error, the notification service 406 may quickly alert relevant components, and allow rapid error resolution and system recovery. In addition, the notification service 406 may relay progress updates to the user device 114 and provide users with real-time information about their subtitle generation requests. Further, based on an aggregation of status updates from various components, the notification service 406 may facilitate comprehensive system monitoring and performance optimization.

The notification service 406 may implement adaptive communication strategies based on the nature and priority of the information being exchanged. For instance, it may use different communication channels or protocols for urgent error messages versus routine status updates. In some cases, the notification service 406 may be implemented as a Real-time Notification Service (RNS), that utilizes technologies such as publish-subscribe patterns or event-driven architectures. This approach may allow for efficient, scalable, and flexible communication across the subtitle information generation system of the scenario 400. The notification service 406 may also incorporate logging and auditing capabilities, to record all communication events for later analysis, troubleshooting, or compliance purposes. This feature may be particularly useful for identifying patterns in system behavior or tracking the root causes of issues that arise during the subtitle generation process.

The internal REST API 408 may provide a standardized interface for communication between the SAG 404 and the subtitle information service bus 410. The internal REST API 408 may handle the translation of external requests into internal commands that may be processed by the various microservices. The internal REST API 408 may be coupled with the SAG 404 and the notification service 406, where the notification service 406 sends the parsed command to the internal REST API 408 based on which the subtitle information service bus 410 may be initiated.

In an embodiment, the electronic device 102 may receive a status request from the user device 114. Then, the job queue & thread manager 412 may determine the status of the subtitle information generation process and transmit the determined status to the internal REST API 408. Further, when the internal REST API 408 receives the status as completed, then the internal REST API 408 may send a request for a response, such as, output data, to the subtitle information service bus 410. The response may include the generated subtitle information in, for example, but not limited to, a JSON format. Further, the internal REST API 408 may receive a response including output data in JSON format and the status of the subtitle information generation. Further, the internal REST API 408 may send the received response to the SAG 404 and the status of the subtitle information to the notification service 406.

For example, the output data in JSON-format may be as follows:

```
  Listing 1: JSON formatted example output
  {
  “statusCode”: 200,
  “body”: {
  “message”: “STATUS_OK”,
  “profane_wordlist”: [ ],
  “status”: “COMPLETED”,
  “status_code”: “STATUS_OK”,
  “transcripts”: [
  {
  “end_time”: “4.784062499999999”,
  “end_timestamp”: “00:00:04.784”,
  “profane_transcript”: “”,
  “speaker”: “SPEAKER_00”,
  “start_time”: “0.4978125”,
  “start_timestamp”: “00:00:00.498”,
  “transcript”: “DON'T YOU JUST LOVE TO LAUGH.”,
  “verbal”: “True”
  },
  {
  “class”: “Music”,
  “end_time”: “29.9615625”,
  “end_timestamp”: “00:00:29.962”,
  “start_time”: “27.6328125”,
  “start_timestamp”: “00:00:27.633”,
  “verbal”: “False”
  }
  ]
  }
}
```

The subtitle information service bus 410 may be a lightweight hypertext transfer protocol (HTTP)-server that may function as an intermediary layer, that facilitates communication and coordination between various microservices and the electronic device 102 (for example, a Workflow Process Manager (WPM)). The subtitle information service bus 410 may operate on top of the job queue & thread manager 412 and the internal REST API 408. The subtitle information service bus 410 may initiate an operational thread upon a job creation (such as, a request received for the subtitle information generation). In an embodiment, the subtitle information service bus 410 may download the multimedia content 110 from the server 106, a cloud storage, or the likes. Further, the subtitle information service bus 410 may invoke a decoder pipeline (such as, by use of the decoder 302) to extract an audio element of the multimedia content 110. Further, the extracted audio element may be processed to determine the speech content. The speech content may be utilized to determine the set of speech segments and the set of non-speech segments. Further, the subtitle information service bus 410 may invoke various microservices to process the set of speech segments and the set of non-speech segments to determine the speech metadata and the non-speech metadata. Further, the subtitle information service bus 410 may initiate an application of the first AI model 104A to determine voice captions associated with the multimedia content 110 and initiate an application of the second AI model 104B to determine non-voice captions associated with the multimedia content 110. Furthermore, the subtitle information service bus 410 may be configured to compile the voice captions and the non-voice captions to generate a final output such as the subtitle information in JSON format. The final output, i.e., the generated subtitle information, may be transmitted as a response to the request (and also the HTTP status request), and ensure efficient and streamlined subtitle information generation and management.

The subtitle information service bus 410 may distribute subtitle information generation tasks, associated with the routed authenticated requests, across the set of microservices. The subtitle information service bus 410 may coordinate communication between a set of microservices responsible for various aspects of subtitle information generation such as, speech metadata and non-speech metadata determination. The microservices associated with the subtitle information service bus 410 may include the non-voice caption service 414D, the ASR service 414B, the diarization service 414C, the speech detection service 414A, and the audio/video decoder 414E (such as, the decoder 302). Each of the microservices may perform specialized functions in the subtitle information generation. In an embodiment, each of the microservices may be a lightweight HTTP server that may receive commands from the internal REST API 408.

The job queue & thread manager 412 may be a component of the subtitle information service bus 410 that may ensure an efficient handling and processing of subtitle information generation tasks. The job queue may maintain an availability and order of all incoming jobs such as request for subtitle information generation, to prevent request timeout scenarios based on management of the time-to-live (TTL) limits of the HTTP requests. When the subtitle information service bus 410 receives a new job and the queue is empty, an entry may be created, and a separate thread may be initiated to keep the processing active. When a job is already running, the new request may be added to the queue, and a job ID may be returned to the MAM application 402 for status tracking. Upon completion of the current job, the job queue & thread manager 412 may process the next job in the queue. The notification service 406 may ensure that the job entries and thread management tasks be coordinated such that an overall workflow of the subtitle information generation may be streamlined.

The job queue & thread manager 412 may further be used for processing multiple subtitle requests concurrently. The job queue & thread manager 412 may manage a distribution and prioritization of subtitle information generation tasks across resources of available electronic devices (such as, the electronic device 102). In an embodiment, the electronic device 102 may utilize job threading to concurrently process multiple subtitle information generation tasks for different portions of the multimedia content 110. The job queue & thread manager 412 may manage the processing of multiple requests, that ensures efficient utilization of the resources of the electronic device 102. As the subtitle information generation process progresses, the notification service 406 may provide real-time updates to the relevant components and, if necessary, to the user device 114 through the SAG 404.

The speech detection service 414A may detect and isolate speech segments from the audio. The speech detection service 414A may serve as a machine learning model trained to detect whether the input frame such as the multimedia content 110 includes the speech content. The speech detection service 414A may segment the multimedia content 110 into a plurality of time-based frames to detect the speech content within each of the plurality of time-based frames. For example, the audio elements of the multimedia content 10 may be divided into equal size frames in a time domain, e.g., 20 ms frame length. The frames may also overlap. Each frame from a training set may be labelled as the set of speech segments or set of non-speech segments for the training. During an inference phase, the speech detection service 414A may process the input frames through the forward path and predict labels associated with each of the frame from the input frames.

The automatic speech recognition (ASR) service 414B may perform automatic speech recognition to convert set of speech segments to text such as voice captions. The ASR service 414B may be a neural network-based system/model that may convert the set of speech segment of the multimedia content 110 into corresponding voice captions. When the set of speech segments are detected by the speech detection service 414A, the set of speech segments may be sent to the ASR service 414B. The ASR service 414B may utilize a trained neural network model to accurately predict and transcribe the spoken words into voice captions. The transcribed voice captions may then be forwarded to a dictionary-based profane word detection module such as the profanity detection model 306C, where the voice captions may be analyzed for any censored or inappropriate words. The ASR service 414B may play a crucial role in the subtitle information generation process based on an output of accurate text transcriptions of spoken language, that may further be processed for content moderation and compliance.

The diarization service 414C may identify and distinguish between different speakers in the speech content of the multimedia content 110. The diarization service 414C may be a neural network-based system that may identify and distinguish between different speakers/users within a given input speech signal such as the speech content of the multimedia content 110. The diarization service 414C may utilizes a trained neural network model to predict and assign user identities to each speech segment of the set of speech segments. The diarization service 414C may enable the electronic device 102 to accurately attribute each speech segment of the set of speech segment to specific users/speakers, and facilitate tasks such as transcription, speaker-specific analysis, and enhancement of an overall understanding of multi-speaker multimedia content.

The non-voice caption service 414D may generate non-voice captions for non-speech metadata. The non-voice caption service 414D may be a lightweight HTTP server associated with a machine learning model that may be trained to predict the class of the non-speech metadata or the speech metadata. The set of speech segments and the set of non-speech segments detected by the speech detection service 414A may be sent to the non-voice caption service 414D service as an input to predict the corresponding class, for examples, but not limited to, baby crying, engine starting, people cheering, and the likes.

The non-voice caption service 414D may utilize deep learning models, such as convolutional neural networks or recurrent neural networks, to classify and describe complex audio events. In some implementations, it may employ transfer learning techniques to adapt pre-trained audio classification models to specific types of content. The non-voice caption service 414D may incorporate a large database of pre-classified sound effects and ambient noises, that allows for quick and accurate identification of common non-speech audio elements in various types of media content.

In some respects, the non-voice caption service 414D may employ natural language generation techniques to create diverse and contextually appropriate textual descriptions for identified non-speech sounds. In some implementations, the non-voice caption service 414D may use multi-modal analysis, to combine audio features with visual information from the video content to improve the accuracy and relevance of generated non-voice captions. The non-voice caption service 414D may incorporate user feedback mechanisms to continuously improve its classification and description capabilities, learning from corrections or preferences provided by human reviewers or end-users.

The audio/video decoder 414E (e.g., the decoder 302) may extract speech content from the multimedia content. Details associated with the audio/video decoder 414E is described further, for example, with reference to the decoder 302, in FIG. 3. Thus, the details of the audio/video decoder 414E may be omitted here for the sake of brevity.

In an embodiment, the electronic device 102 may determine confidence scores for voice captions and non-voice captions generated by the various microservices. The confidence scores may be used to assess the quality of the generated subtitle information and may inform about a necessity of post-processing or human verification steps.

In operation, the electronic device 102 may receive a subtitle information generation request from the SAG 404. The request may be authenticated and then routed to the internal REST API 408 by the SAG 404. The internal REST API 408 may then communicate with the subtitle information service bus 410 to initiate the subtitle information generation process. The subtitle information service bus 410 may coordinate the various microservices (414A-414E) to process the multimedia content 110 and generate the requested subtitles information.

The job queue & thread management 412 may manage the processing of multiple requests, ensuring efficient utilization of system resources. As the subtitle generation process progresses, the notification service 406 may provide real-time updates to the relevant components and, if necessary, to the client through the secure API gateway 404. The media asset management application 402 may interact with this subtitle generation system to manage the overall process of subtitle creation, storage, and distribution. The media asset management application 402 may send requests through the secure API gateway 404 and receive the generated subtitles and associated metadata for integration with the original multimedia content (e.g., the multimedia content 110). The subtitle generation system may be a scalable and efficient system for automated subtitle generation, that leverages specialized microservices and robust management components to handle complex multimedia processing tasks.

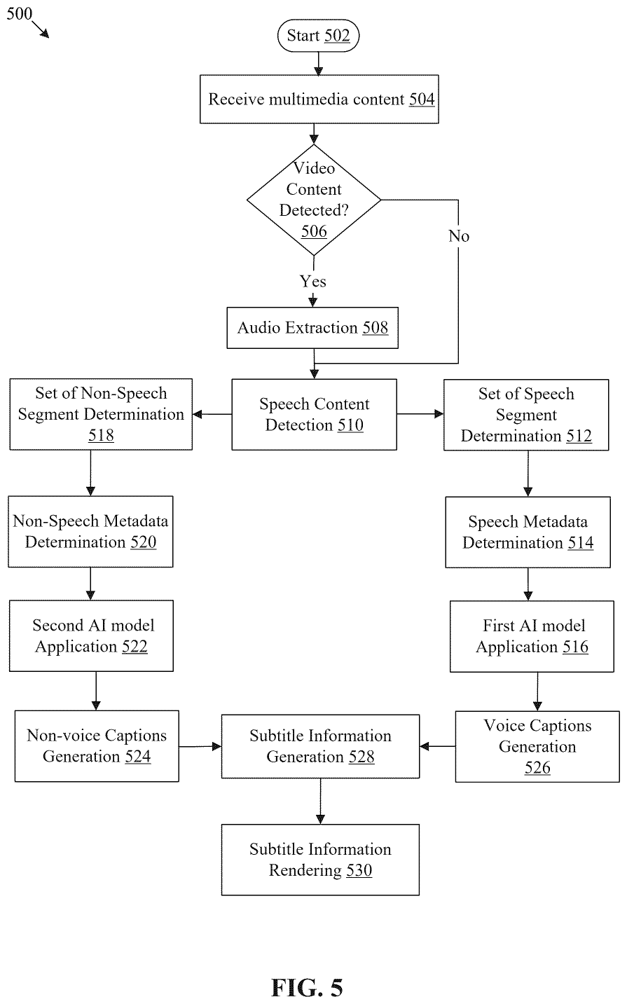

FIG. 5 is a flow diagram that illustrates an exemplary processing of multimedia content for speech and non-speech subtitle information generation, in accordance with an embodiment of the disclosure. FIG. 5 is explained in conjunction with elements from FIG. 1, FIG. 2, FIG. 3, and FIG. 4. With reference to FIG. 5, there is shown an exemplary flowchart 500. An exemplary method depicted in the flowchart 500 may include operations from 502 to 530 that may be implemented by the electronic device 102 of FIG. 1 or by the circuitry 202 of FIG. 2. The exemplary flowchart 500 may start at 502 and proceed to 504.

At 504, multimedia content may be received. The circuitry 202 may be configured to receive the multimedia content 110 including speech content through the network interface 208 from the server 106, the memory 204 of the electronic device 102, or the user device 114. For example, the electronic device 102 may receive a full-length movie file from the server 106 through the communication network 112. The movie file may contain both video and audio tracks, with the audio track including dialogue, background music, and sound effects. The reception of multimedia content 110 may be initiated through a request from the MAM application 402. For example, the request may be authenticated by the SAG 404 before being processed by the electronic device 102. The multimedia content 110 may be temporarily stored in the memory 204 for further processing.

At 506, video content may be detected. The circuitry 202 may be configured to detect whether the video content is present in the multimedia content 110. The circuitry 202 may be configured to analyze the received multimedia content 110 to identify the presence of video data. For example, when the received multimedia content 110 is an audio podcast, the circuitry 202 may determine that no video content may be present. Conversely, when the multimedia content 110 is a television show episode, the circuitry 202 may detect the presence of video data. Thus, the step 506 may be crucial for optimization of the subsequent processing. When the video content is detected, additional synchronization between the generated subtitle information and the video frames may be required. In such a case, control may pass to 508 and audio extraction may be performed. However, when no video content is detected, the subtitle information generation process may focus solely on the audio element. In such a case, control may pass to 510 and speech content may be detected.

At 508, audio extraction may be performed. The circuitry 202 may be configured to separate the audio element from the video data detected at the step 506. For example, when the multimedia content 110 is a movie file, the circuitry 202 may extract the audio element, that may include dialogues, background music, and sound effects. The extracted audio element may then be processed independent of the video content. The audio extraction process may involve decoding the multimedia content 110 and isolating the audio element. In an embodiment, the decoder 302 may be utilized for the audio element extraction. The extracted audio element may be stored temporarily in the memory 204 of the electronic device 102 for further analysis.

At 510, speech content may be detected. The circuitry 202 may be configured to detect the speech content from the multimedia content 110 to determine the set of speech segments and the set of non-speech segments. The circuitry 202 may be configured to analyze the speech content and distinguish between the set of speech segments and the set of non-speech segments. For example, in a news broadcast, the circuitry 202 may identify segments where the news anchor is speaking as the set of speech segments, while background music or sound effects may be classified as the set of non-speech segments.

The step 510 may be crucial for the parallel processing of the set of speech segments and the set of non-speech segments. The speech content detection process may involve analyzing various audio elements such as frequency, amplitude, and spectral characteristics to differentiate between the set of speech segments and the set of non-speech segments.

At 512, set of speech segments may be determined. The circuitry 202 may be configured to determine a set of speech segments from the speech content of the multimedia content 110. The circuitry 202 may isolate and extract the identified set of speech segments from the speech content such as, the audio content. For example, in a podcast that features multiple speakers/users, the circuitry 202 may identify and extract individual segments where each speaker may be talking. The extracted set of speech segments may then be processed further for transcription and speaker identification. The determination of set of speech segments may involve time-stamping each segment to maintain synchronization with the multimedia content 110. In an embodiment, the circuitry 202 may also perform preliminary noise reduction on the set of speech segments to improve the accuracy of subsequent processing steps.

At 514, speech metadata may be determined. The circuitry 202 may be configured to determine the speech metadata based on the set of speech segments. The circuitry 202 may be configured to analyze the set of speech segments and extract relevant speech metadata. For example, the circuitry 202 may analyze a speech segment of the set of speech segments from a political debate and determine speech metadata such as the spoken text, an identity of the speaker, and a profanity score for the spoken text of the spoken content. The speech metadata may further include various attributes that may provide context and additional information about the speech content. The speaker diarization model 306A may be used to identify and distinguish between different users/speakers. The profanity detection model 306C may analyze the spoken text to assign a profanity score, that may be used later for content filtering or age-appropriate subtitle information generation.

At 516, application of the first AI model 104A may be performed. The circuitry 202 may be configured to apply the first AI model 104A to the speech metadata. The application of the first AI model 104A may process the speech metadata. For example, the first AI model 104A may analyze the speech metadata from a news broadcast to determine the context, sentiment, and key topics of the spoken content. The analysis may enhance the accuracy and relevance of the generated subtitle information. The application of the first AI model 104A may include a natural language processing technique to understand the nuances of the speech content (such as the human speech content) of the multimedia content 110. In an embodiment, the first AI model 104A may be trained to recognize industry-specific terminology, accents, or speaking styles to improve the performance across various types of speech content.

At 518, set of non-speech segments may be determined. The circuitry 202 may be configured to determine a set of non-speech segments from the speech content of the multimedia content 110. The circuitry 202 may be configured to isolate and extract the determined set of non-speech segments from the speech content of the multimedia content 110. For example, in a nature documentary, the circuitry 202 may determine the set of non-voice segments such as non-voice segment of animal sounds, flow of a water-stream or rustling of a wind. The set of non-speech segments may provide important contextual information for users/viewers of the multimedia content 110, especially those who are deaf or hard of hearing. The determination of the set of non-speech segments may include categorization of different sounds. The non-speech processor 308 may be employed to classify the non-speech audio event into categories such as music, ambient noise, or specific sound effects. The classification may be used for generating descriptive non-voice captions for the set of non-speech segment of the speech content.

At 520, non-speech metadata may be determined. The circuitry 202 may be configured to determine the non-speech metadata based on the set of non-speech segments. The circuitry 202 may be configured to analyze the set of non-speech segments and extract relevant non-speech metadata. For example, in an action movie scene, the circuitry 202 may analyze each non-speech segment of the set of non-speech segments and determine non-speech metadata for each non-speech segment. The non-speech metadata may be, such as, but not limited to, the type of sound (e.g., explosion), an intensity, and a duration associated with the non-speech segment. The non-speech metadata may further be used in generation of the non-voice captions. In an embodiment, the non-speech metadata may include various attributes that may describe the acoustic characteristics and context of each non-speech segment of the set of non-speech segments. Further, the metadata may also include temporal information that ensures proper synchronization with the visual content of the multimedia content 110.

At 522, application of the second AI model 104B may be performed. The circuitry 202 may be configured to process the non-speech metadata using the second AI model 104B. For example, the multimedia content 110 is a sports broadcast, then the second AI model 104B may be configured to analyze the non-speech metadata of the sports broadcast to identify and classify crowd cheers, referee whistles, or the sound of a ball being hit. The analysis may enable the generation of descriptive and context-aware non-voice captions. The application of the second AI model 104B may include the ML techniques specifically designed for speech content (audio event) detection and classification. The second AI model 104B may be trained on a diverse range of non-speech segment of the speech content to accurately identify and describe audio events in different multimedia content.

At 524, non-voice captions may be generated. The circuitry 202 may be configured to generate the non-voice cations associated with the multimedia content 110, based on the applied second AI model 104B. In an embodiment, the circuitry 202 may be configured to create textual descriptions for the non-speech metadata of the set of non-speech segments. For example, if the multimedia content 110 is a horror movie, then the circuitry 202 may generate the non-voice captions such as “[Eerie music intensifies]” or “[Floorboard creaks]” based on the analysis of the non-speech metadata associated with the set of non-speech segment by the second AI model 104B. In another embodiment, the generation of non-voice captions may include translation of the classified audio events into concise, descriptive text. The non-voice caption service 414D may be utilized for the generation of the non-voice captions. In an embodiment, the electronic device 102 may use a predefined vocabulary of descriptive terms to ensure consistency and clarity in the non-voice captions across different multimedia content.

At 526, voice captions may be generated. The circuitry 202 may be configured to generate the voice captions associated with the multimedia content 110, based on the application of the first AI model 104A. The circuitry 202 may be configured to create textual transcriptions of the speech content. For example, if the multimedia content 110 is a courtroom drama, then the circuitry 202 may generate the voice captions that accurately transcribe the dialogue, including speaker identification and any relevant speech inflections or emotions detected by the first AI model 104A. Further, the generation of voice captions may include conversion of the analyzed speech metadata into a readable text. The speech recognition model 306B may be used in conjunction with the results from the first AI model 104A to produce accurate and context-aware transcriptions. In another embodiment, the circuitry 202 may also incorporate speaker labels and time codes to enhance the usability of the voice captions.

At 528, subtitle information may be generated. The circuitry 202 may be configured to generate the subtitle information associated with the multimedia content 110, based on the voice captions and the non-voice captions. The circuitry 202 may be configured to combine and format the voice captions and the non-voice captions into a cohesive subtitle information track. For example, in a documentary film, the circuitry 202 may generate subtitle information that seamlessly integrates transcribed narration (voice captions) with descriptions of background music or environmental sounds (non-voice captions). The generation of subtitle information may include determination of a combination of the voice captions and the non-voice captions while a synchronization of the voice captions and the non-voice captions is maintained with respect to the multimedia content 110. The subtitle information generator 314 may be employed for integration of the voice captions and the non-voice captions. In an embodiment, the circuitry 202 may apply formatting rules to distinguish between different captions, such as using italics for the non-voice captions or multiple colors for different speakers/users.

At 530, subtitle information may be rendered. The circuitry 202 may be configured to control rendering of the multimedia content 110 with the subtitle information. The circuitry 202 may be configured to synchronize the generated subtitle information with the playback of the multimedia content 110. For example, when the streamed multimedia content 110 is a foreign language film on the user device 114, then the circuitry 202 may ensure that the generated subtitle information may appear at the correct times, matching the spoken content and the relevant non-speech segment. The control of rendering may include integration of the subtitle information with the video playback. In an embodiment, the electronic device 102 may generate a standardized subtitle file format (such as SRT or WebVTT) that may be easily incorporated into various media players. The electronic device 102 may also provide options for customization of an appearance of the subtitle information, such as font size, color, or position on the screen, to enhance readability and the user experience. Control may pass to end.

Although the exemplary flowchart 500 is illustrated as discrete operations, such as 504, 506, 508, 510, 512, 514, 516, 518, 520, 522, 524, 526, 528, and 530, the disclosure is not so limited. Accordingly, in certain embodiments, such discrete operations may be further divided into additional operations, combined into fewer operations, or eliminated, depending on the implementation without detracting from the essence of the disclosed embodiments.

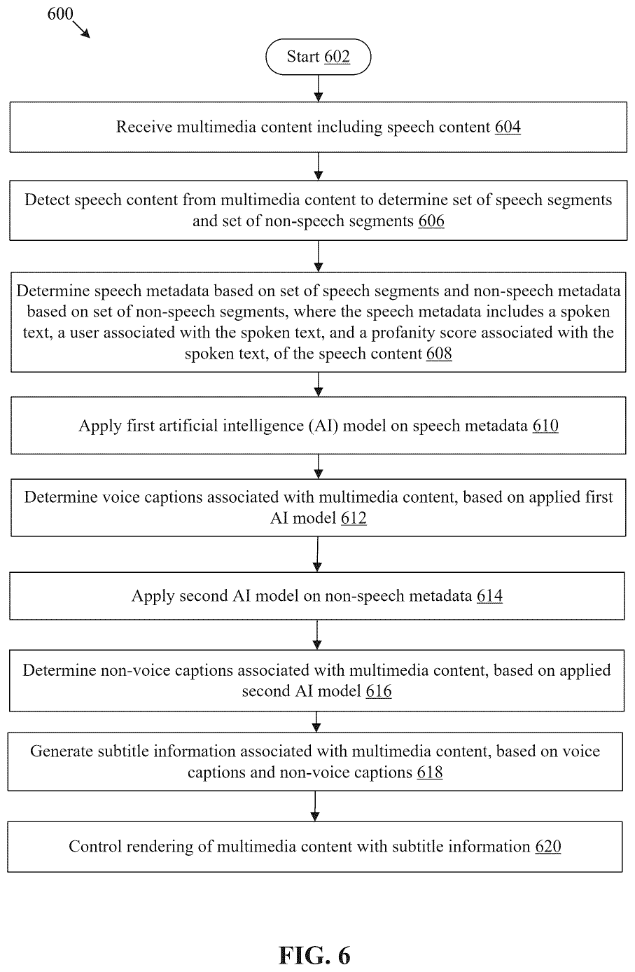

FIG. 6 is a flowchart that illustrates operations of an exemplary method for artificial intelligence (AI) based speech and non-speech subtitle information generation for multimedia content, in accordance with an embodiment of the disclosure. FIG. 6 is described in conjunction with elements from FIG. 1, FIG. 2, FIG. 3, FIG. 4, and FIG. 5. With reference to FIG. 6, there is shown an exemplary flowchart 600. An exemplary method depicted in the flowchart 600 may include operations from 602 to 616 that may be implemented by the electronic device 102 of FIG. 1 or by the circuitry 202 of FIG. 2. The exemplary flowchart 600 may start at 602 and proceed to 604.

At 604, multimedia content including speech content may be received. The circuitry 202 may be configured to receive the multimedia content 110 including the speech content through the network interface 208. The reception of multimedia content is described further, for example, in FIG. 4 (where the media asset management application 402 may initiate the process by sending a request through the SAG 404).

At 606, speech content may be detected from the multimedia content to determine a set of speech segments and a set of non-speech segments. The circuitry 202 may be configured to detect the speech content from the multimedia content 110 to determine the set of speech segments and the set of non-speech segments. The speech content detection is described further, for example, in FIG. 3 (where the speech content detector 304 may performs the speech content detection task).

At 608, speech metadata may be determined based on the set of speech segments and non-speech metadata may be determined based on the set of non-speech segments. The circuitry 202 may be configured to determine the speech metadata based on the set of speech segments and determine the non-speech metadata based on the set of non-speech segments. The speech metadata may include a spoken text, a user associated with the spoken text, and a profanity score associated with the spoken text of the speech content. The speech metadata and non-speech metadata determination is described further, for example, in FIG. 3 (where the speech processor 306 and non-speech processor 308 may perform the speech metadata and the non-speech metadata determination tasks respectively).

At 610, a first artificial intelligence (AI) model may be applied to the speech metadata. The circuitry 202 may be configured to apply the first AI model 104A to the speech metadata. The application of the first AI model is described further, for example, in FIG. 3 (where the speech recognition model 306B may utilize the first AI model 104A).

At 612, voice captions associated with the multimedia content may be determined, based on the applied first AI model. The circuitry 202 may be configured to determine the voice captions associated with the multimedia content 110 based on the applied first AI model 104A. The voice captions determination is described further, for example, in FIG. 3 (where the voice captions generator 310 may perform the voice cations determination task).

At 614, a second AI model may be applied to the non-speech metadata. The circuitry 202 may be configured to determine the apply the second AI model 104B to the non-speech metadata. The application of the second AI model is described further, for example, in FIG. 4 (where the non-voice caption service 414D may utilize the second AI model 104B).

At 616, non-voice captions associated with the multimedia content may be determined, based on the applied second AI model. The circuitry 202 may be configured to determine the non-voice captions associated with the multimedia content 110 based on the applied second AI model 104B. The non-voice captions determination is described further, for example, in FIG. 3 (where the non-voice captions generator 312 may perform the non-voice captions determination task).

At 618, subtitle information associated with the multimedia content may be generated, based on the voice captions and the non-voice captions. The circuitry 202 may be configured to generate the subtitle information associated with the multimedia content 110, based on the voice captions and the non-voice captions. The circuitry 202 may be configured to combine and format the voice captions and the non-voice captions into a cohesive subtitle information track. The subtitle information generation is described further, for example, in FIG. 3 (where the subtitle information generator 314 may perform the subtitle information generation task).

At 620, rendering of the multimedia content may be controlled with the subtitle information. The circuitry 202 may be configured to control the rendering of the multimedia content 110 with the subtitle information. The circuitry 202 may be configured to synchronize the generated subtitle information with the playback of the multimedia content 110. The rendering control is described further, for example, in FIG. 1 (where the user device 114 may display the multimedia content 110 with the generated subtitle information). Control may pass to end.

Although the exemplary flowchart 600 is illustrated as discrete operations, such as 604, 606, 608, 610, 612, 614, 616, 618, and 620, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, The electronic device 102 of FIG. 1). Such instructions may cause the electronic device 102 to perform operations that may include may reception of multimedia content (e.g., the multimedia content 110) including speech content. The operations may further include detection of the speech content from the multimedia content 110 to determine a set of speech segments and a set of non-speech segments. The operations may further include determination of speech metadata based on the set of speech segments and non-speech metadata based on the set of non-speech segments. The speech metadata includes a spoken text, a user associated with the spoken text, and a profanity score associated with the spoken text, of the speech content. The operations may further include application of a first artificial intelligence (AI) model (e.g., the first AI model 104A) on the speech metadata. The operations may further include determination of voice captions associated with the multimedia content 110, based on the applied first AI model 104A. The operations may further include application of a second AI model (e.g., the second AI model 104B) on the non-speech metadata. The operations may further include determination of non-voice captions associated with the multimedia content 110, based on the applied second AI model 104B. The operations may further include generation of subtitle information associated with the multimedia content, based on the voice captions and the non-voice captions. The operations may further include control of rendering of the multimedia content 110 with the subtitle information.

Exemplary aspects of the disclosure may provide an electronic device (such as, the electronic device 102 of FIG. 1) that includes circuitry (such as, the circuitry 202). The circuitry 202 may be configured to receive multimedia content (e.g., the multimedia content 110) including speech content. The circuitry 202 may detect the speech content from the multimedia content to determine a set of speech segments and a set of non-speech segments. The circuitry 202 may determine speech metadata based on the set of speech segments and non-speech metadata based on the set of non-speech segments. The speech metadata includes a spoken text, a user associated with the spoken text, and a profanity score associated with the spoken text, of the speech content. The circuitry 202 may apply a first artificial intelligence (AI) model (e.g., the first AI model 104A) to the speech metadata. The circuitry 202 may determine voice captions associated with the multimedia content 110, based on the applied first AI model 104A. The circuitry 202 may apply a second AI model (e.g., the second AI model 104B) to the non-speech metadata. The circuitry 202 may determine non-voice captions associated with the multimedia content 110, based on the applied second AI model 104B. The circuitry 202 may generate subtitle information associated with the multimedia content 110, based on the voice captions and the non-voice captions. The circuitry 202 may control rendering of the multimedia content 110 with the subtitle information.

In an embodiment, the circuitry 202 may further be configured to control a Media Asset Management (MAM) server to organize and distribute the multimedia content 110 and the generated subtitle information.

In an embodiment, the circuitry 202 may further configured to utilize job threading to concurrently process multiple subtitle information generation tasks for different portions of the multimedia content 101.

In an embodiment, the electronic device 102 may comprise a web API to enable remote access and control of the generation of the subtitle information.

In an embodiment, the circuitry 202 may further configured to control a subtitle information service bus to coordinate communication between a set of microservices responsible for the speech content detection, the first AI model application, the second AI model application, and the voice caption determination, and the non-voice caption determination.

In an embodiment, the circuitry 202 may further configured to receive subtitle information generation requests through a secure API gateway. The secure API gateway is configured to authenticate the subtitle information generation requests. The circuitry 202 may be configured to route the authenticated requests to the subtitle information service bus. The circuitry 202 may be configured to distribute, by use of the subtitle information service bus, subtitle information generation tasks, associated with the routed authenticated requests, across the set of microservices.

In an embodiment, the circuitry 202 may further configured to determine a confidence score for each of the voice captions and the non-voice captions. The generation of the subtitle information is further based on the confidence score.

In an embodiment, the circuitry 202 may further configured to segment the multimedia content into a plurality of time-based frames and detect the speech content within each of the plurality of time-based frames.

In an embodiment, the circuitry 202 may further configured to apply a speech diarization technique to identify multiple speakers within the speech content and determine an association between each of the multiple speakers and corresponding portions of the spoken text.

In an embodiment, the circuitry 202 may further configured to classify the non-speech segments into categories including at least one of music, applause, or sound effects.

In an embodiment, the circuitry 202 may further configured to filter the spoken text based on the profanity score to generate filtered voice captions. The generated subtitle information includes the filtered voice captions.

In an embodiment, the first AI model comprises a natural language processing model trained to analyze a context and a sentiment of the speech metadata.

In an embodiment, the second AI model comprises a machine learning (ML) model trained to classify non-speech audio events.

In an embodiment, the circuitry 202 may further configured to synchronize the voice captions and the non-voice captions with corresponding portions of the multimedia content.

In an embodiment, the circuitry 202 may further configured to receive user feedback on the generated subtitle information and update at least one of the first AI model or the second AI model based on the user feedback.

In an embodiment, the circuitry 202 may further configured to generate a subtitle file in a standardized format based on the generated subtitle information.

In an embodiment, the circuitry 202 may further configured to detect a language of the speech content and translate the voice captions into one or more target languages. The generated subtitle information includes the translated voice captions.

In an embodiment, the circuitry 202 may further configured to adjust a display format of the generated subtitle information based on display characteristics of a rendering device.

The present disclosure may also be positioned in a computer program product, which comprises all the features that enable the implementation of the methods described herein, and which when loaded in a computer system is able to conduct these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive multimedia content including speech content;
detect the speech content from the multimedia content to determine a set of speech segments and a set of non-speech segments;
determine speech metadata based on the set of speech segments and non-speech metadata based on the set of non-speech segments, wherein
the speech metadata includes a spoken text, a user associated with the spoken text, and a profanity score associated with the spoken text, of the speech content;
apply a first artificial intelligence (AI) model to the speech metadata;
determine voice captions associated with the multimedia content, based on the applied first AI model;
apply a second AI model to the non-speech metadata;
determine non-voice captions associated with the multimedia content, based on the applied second AI model;
generate subtitle information associated with the multimedia content, based on the voice captions and the non-voice captions; and
control rendering of the multimedia content with the subtitle information.

2. The electronic device of claim 1, wherein the circuitry is further configured to control a Media Asset Management (MAM) server to organize and distribute the multimedia content and the generated subtitle information.

3. The electronic device of claim 1, wherein the circuitry is further configured to utilize job threading to concurrently process multiple subtitle information generation tasks for different portions of the multimedia content.

4. The electronic device of claim 1, further comprising a web application programming interface (API) to enable remote access and control of the generation of the subtitle information.

5. The electronic device of claim 1, wherein the circuitry is further configured to control a subtitle information service bus to coordinate communication between a set of microservices responsible for the speech content detection, the first AI model application, the second AI model application, and the voice caption determination, and the non-voice caption determination.

6. The electronic device of claim 5, wherein the circuitry is further configured to:
receive subtitle information generation requests through a secure API gateway, wherein
the secure API gateway is configured to authenticate the subtitle information generation requests;
route the authenticated requests to the subtitle information service bus; and
distribute, by use of the subtitle information service bus, subtitle information generation tasks, associated with the routed authenticated requests, across the set of microservices.

7. The electronic device of claim 1, wherein the circuitry is further configured to:
determine a confidence score for each of the voice captions and the non-voice captions, wherein
the generation of the subtitle information is further based on the confidence score.

8. The electronic device of claim 1, wherein the circuitry is further configured to:
segment the multimedia content into a plurality of time-based frames; and
detect the speech content within each of the plurality of time-based frames.

9. The electronic device of claim 1, wherein the circuitry is further configured to:
apply a speech diarization technique to identify multiple speakers within the speech content; and
determine an association between each of the multiple speakers and corresponding portions of the spoken text.

10. The electronic device of claim 1, wherein the circuitry is further configured to classify the non-speech segments into categories including at least one of music, applause, or sound effects.

11. The electronic device of claim 1, wherein the circuitry is further configured to:
filter the spoken text based on the profanity score to generate filtered voice captions, wherein
the generated subtitle information includes the filtered voice captions.

12. The electronic device of claim 1, wherein the first AI model comprises a natural language processing model trained to analyze a context and a sentiment of the speech metadata.

13. The electronic device of claim 1, wherein the second AI model comprises a machine learning (ML) model trained to classify non-speech audio events.

14. The electronic device of claim 1, wherein the circuitry is further configured to synchronize the voice captions and the non-voice captions with corresponding portions of the multimedia content.

15. The electronic device of claim 1, wherein the circuitry is further configured to:
receive a user feedback on the generated subtitle information; and
update at least one of the first AI model or the second AI model based on the user feedback.

16. The electronic device of claim 1, wherein the circuitry is further configured to generate a subtitle file in a standardized format based on the generated subtitle information.

17. The electronic device of claim 1, wherein the circuitry is further configured to:
detect a language of the speech content; and
translate the voice captions into one or more target languages, wherein the generated subtitle information includes the translated voice captions.

18. The electronic device of claim 1, wherein the circuitry is further configured to adjust a display format of the generated subtitle information based on display characteristics of a rendering device.

19. A method, comprising:
in an electronic device:
receiving multimedia content including speech content;
detecting the speech content from the multimedia content to determine a set of speech segments and a set of non-speech segments;
determining speech metadata based on the set of speech segments and non-speech metadata based on the set of non-speech segments, wherein
the speech metadata includes a spoken text, a user associated with the spoken text, and a profanity score associated with the spoken text, of the speech content;
applying a first artificial intelligence (AI) model to the speech metadata;
determining voice captions associated with the multimedia content, based on the applied first AI model;
applying a second AI model to the non-speech metadata;
determining non-voice captions associated with the multimedia content, based on the applied second AI model;
generating subtitle information associated with the multimedia content, based on the voice captions and the non-voice captions; and
controlling rendering of the multimedia content with the subtitle information.

20. A non-transitory computer-readable medium having stored thereon, computer-executable instructions that when executed by an electronic device, causes the electronic device to execute operations, the operations comprising:
receiving multimedia content including speech content;
detecting the speech content from the multimedia content to determine a set of speech segments and a set of non-speech segments;
determining speech metadata based on the set of speech segments and non-speech metadata based on the set of non-speech segments, wherein
the speech metadata includes a spoken text, a user associated with the spoken text, and a profanity score associated with the spoken text, of the speech content;
applying a first artificial intelligence (AI) model to the speech metadata;
determining voice captions associated with the multimedia content, based on the applied first AI model;
applying a second AI model to the non-speech metadata;
determining non-voice captions associated with the multimedia content, based on the applied second AI model;
generating subtitle information associated with the multimedia content, based on the voice captions and the non-voice captions; and
controlling rendering of the multimedia content with the subtitle information.
